(19) United States
(12) Patent Application Publication
(10) Pub. No.: US 2025/0085927 A1
(43) Pub. Date: Mar. 13, 2025

(54) AUTOMATED COMPRESSION OF LOGICAL RULE SETS INTO EXECUTABLE FORM

(71) Applicant: Express Scripts Strategic Development, Inc., St. Louis, MO (US)

(72) Inventor: Christopher Sardegna, Los Angeles, CA (US)

(21) Appl. No.: 18/367,741

(22) Filed: Sep. 13, 2023

(51) Int. Cl. G06F 7/76

(52) U.S. Cl. CPC G06F 7/76

(57) ABSTRACT

A computerized method includes initiating, via a user, an operation on logical descriptive data stored in a storage device, the logical descriptive data includes a set of uncompressed rules each including a set of conditions expressed as a Boolean algebraic expression. The method includes determining whether each of the uncompressed rules includes a singleton rule or a nested rule. The method includes, in response to at least one of the uncompressed rules including a nested rule, compressing the nested rule to form a compressed rule, replacing the nested rule with the compressed rule, and updating the logical descriptive data to include the compressed rule.

### FIELD

The present disclosure relates to digital compression and, more particularly, to compression of sets of computer-encoded logical rules.

### SUMMARY

A computerized method includes initiating, via a user, an operation on logical descriptive data stored in a storage device, the logical descriptive data includes a set of uncompressed rules each including a set of conditions expressed as a Boolean algebraic expression. The method includes determining whether each of the uncompressed rules includes a singleton rule or a nested rule. The method includes, in response to at least one of the uncompressed rules including a nested rule, compressing the nested rule to form a compressed rule, replacing the nested rule with the compressed rule, and updating the logical descriptive data to include the compressed rule.

In other features, initiating the operation on the logical descriptive data includes at least one of modifying some of the logical descriptive data, updating some of the logical descriptive data, and adding new data. In other features, each of the uncompressed rules includes a set of actions to take if the set of conditions is met. In other features, determining whether each of the uncompressed rules includes a singleton rule or a nested rule includes determining whether the set of conditions of each of the uncompressed rules includes a singleton type or a nested type.

In other features, the method includes, in response to at least one of the uncompressed rules including a set of conditions having the singleton type, generating a unique identifier that can be used to store and retrieve the set of conditions having the singleton type in a hash map data structure. In other features, the method includes, in response to at least one of the uncompressed rules including a set of conditions having the nested type, determining the nesting types of a parent condition of the set of conditions and a set of child conditions of the set of conditions.

In other features, the method includes, in response to the set of child conditions including multiple child conditions having a nesting type matching the parent condition, moving at least one of the child conditions into the parent condition. In other features, the method includes, in response to the set of child conditions including multiple child conditions having a different nesting type as the parent condition, collapsing at least one of the child conditions into the parent condition.

In other features, the method includes, in response to the set of child conditions including a single child condition, promoting the single child condition into the parent condition. In other features, the method includes executing a simulation using the logical descriptive data including the compressed rule and determining a valuation value of the logical descriptive data. In other features, the logical descriptive data includes medical pricing data.

In other features, the method includes executing the compressed rule on a data record, determining whether the compressed rule applies to the data record based on the set of conditions of the compressed rule. In other features, the method includes, in response to a determination that the compressed rule applies, performing each action of a set of actions defined by the compressed rule. In other features, the executing the compressed rule is performed without decompressing the compressed rule. In other features, the method includes discarding ones of the set of uncompressed rules that are encompassed by the compressed rule.

A system includes processor hardware and memory hardware configured to store instructions that, when executed by the processor hardware, cause the processor hardware to perform operations. The operations include initiating an operation on logical descriptive data stored in a storage device, the logical descriptive data includes a set of uncompressed rules each including a set of conditions expressed as a Boolean algebraic expression. The system includes determining whether each of the uncompressed rules includes a singleton rule or a nested rule. The system includes, in response to at least one of the uncompressed rules including a nested rule, compressing the nested rule to form a compressed rule, replacing the nested rule with the compressed rule, and updating the logical descriptive data to include the compressed rule.

In other features, initiating the operation on the logical descriptive data includes at least one of modifying some of the logical descriptive data, updating some of the logical descriptive data, and adding new data. In other features, each of the uncompressed rules includes a set of actions to take if the set of conditions is met.

In other features, determining whether each of the uncompressed rules includes a singleton rule or a nested rule includes determining whether the set of conditions of each of the uncompressed rules includes a singleton type or a nested type. In other features, the system includes, in response to at least one of the uncompressed rules including a set of conditions having the singleton type, generating a unique identifier that can be used to store and retrieve the set of conditions having the singleton type in a hash map data structure.

A non-transitory computer-readable medium storing processor-executable instructions, the instructions include initiating an operation on logical descriptive data stored in a storage device, the logical descriptive data includes a set of uncompressed rules each including a set of conditions expressed as a Boolean algebraic expression. The instructions include determining whether each of the uncompressed rules includes a singleton rule or a nested rule. The instructions include, in response to at least one of the uncompressed rules including a nested rule, compressing the nested rule to form a compressed rule, replacing the nested rule with the compressed rule, and updating the logical descriptive data to include the compressed rule.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is a functional block diagram of an example system including a high-volume pharmacy.

FIG. 2 is a functional block diagram of an example pharmacy fulfillment device, which may be deployed within the system of FIG. 1.

FIG. 3 is a functional block diagram of an example order processing device, which may be deployed within the system of FIG. 1.

FIG. 4 is a functional block diagram of an example compression system.

FIG. 5 is an example of a web front-end that a user may use to select, modify, update, add, and/or remove contract elements and/or terms of a contract.

FIG. 6 is an example of a web front-end that a user may use to select claims data to be used in a simulation.

FIG. 7 is a flowchart of an example process for compressing rules of a contract.

FIG. 8 is a flowchart of an example process for simulating execution of a contract.

In the drawings, reference numbers may be reused to identify similar and/or identical elements.

### DETAILED DESCRIPTION

### High-Volume Pharmacy

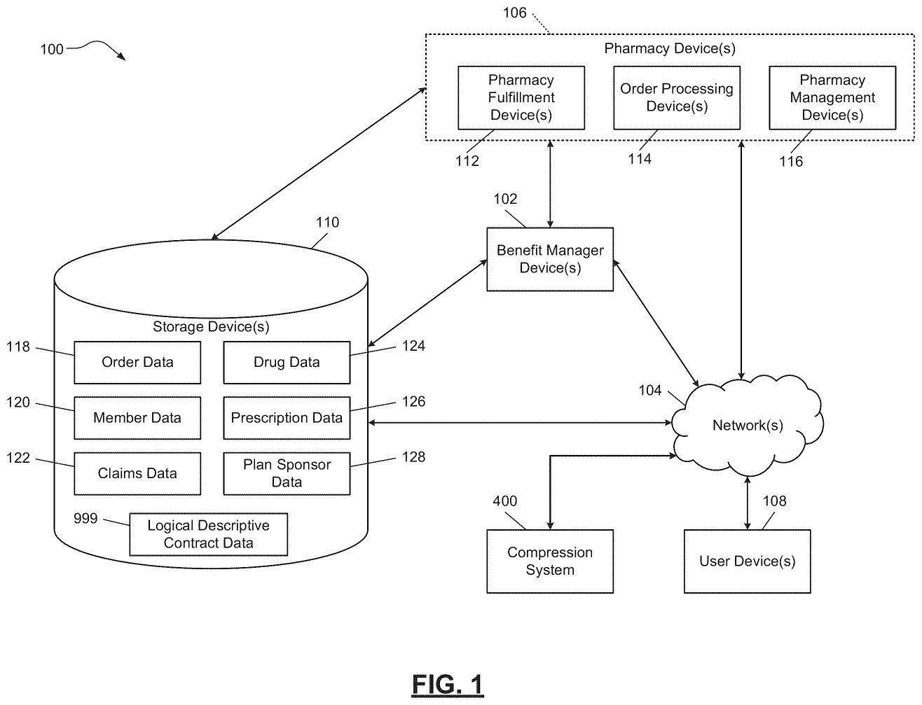

FIG. 1 is a block diagram of an example implementation of a system 100 for a high-volume pharmacy. While the system 100 is generally described as being deployed in a high-volume pharmacy or a fulfillment center (for example, a mail order pharmacy, a direct delivery pharmacy, etc.), the system 100 and/or components of the system 100 may otherwise be deployed (for example, in a lower-volume pharmacy, etc.). A high-volume pharmacy may be a pharmacy that is capable of filling at least some prescriptions mechanically. The system 100 may include a benefit manager device 102 and a pharmacy device 106 in communication with each other directly and/or over a network 104.

The system 100 may also include one or more user device(s) 108. A user, such as a pharmacist, patient, data analyst, health plan administrator, etc., may access the benefit manager device 102 or the pharmacy device 106 using the user device 108. The user device 108 may be a desktop computer, a laptop computer, a tablet, a smartphone, etc.

The benefit manager device 102 is a device operated by an entity that is at least partially responsible for creation and/or management of the pharmacy or drug benefit. While the entity operating the benefit manager device 102 is typically a pharmacy benefit manager (PBM), other entities may operate the benefit manager device 102 on behalf of themselves or other entities (such as PBMs). For example, the benefit manager device 102 may be operated by a health plan, a retail pharmacy chain, a drug wholesaler, a data analytics or other type of software-related company, etc. In some implementations, a PBM that provides the pharmacy benefit may provide one or more additional benefits including a medical or health benefit, a dental benefit, a vision benefit, a wellness benefit, a radiology benefit, a pet care benefit, an insurance benefit, a long term care benefit, a nursing home benefit, etc. The PBM may, in addition to its PBM operations, operate one or more pharmacies. The pharmacies may be retail pharmacies, mail order pharmacies, etc.

Some of the operations of the PBM that operates the benefit manager device 102 may include the following activities and processes. A member (or a person on behalf of the member) of a pharmacy benefit plan may obtain a prescription drug at a retail pharmacy location (e.g., a location of a physical store) from a pharmacist or a pharmacist technician. The member may also obtain the prescription drug through mail order drug delivery from a mail order pharmacy location, such as the system 100. In some implementations, the member may obtain the prescription drug directly or indirectly through the use of a machine, such as a kiosk, a vending unit, a mobile electronic device, or a different type of mechanical device, electrical device, electronic communication device, and/or computing device. Such a machine may be filled with the prescription drug in prescription packaging, which may include multiple prescription components, by the system 100. The pharmacy benefit plan is administered by or through the benefit manager device 102.

The member may have a copayment for the prescription drug that reflects an amount of money that the member is responsible to pay the pharmacy for the prescription drug. The money paid by the member to the pharmacy may come from, as examples, personal funds of the member, a health savings account (HSA) of the member or the member's family, a health reimbursement arrangement (HRA) of the member or the member's family, or a flexible spending account (FSA) of the member or the member's family. In some instances, an employer of the member may directly or indirectly fund or reimburse the member for the copayments.

The amount of the copayment required by the member may vary across different pharmacy benefit plans having different plan sponsors or clients and/or for different prescription drugs. The member's copayment may be a flat copayment (in one example, $10), coinsurance (in one example, 10%), and/or a deductible (for example, responsibility for the first $500 of annual prescription drug expense, etc.) for certain prescription drugs, certain types and/or classes of prescription drugs, and/or all prescription drugs. The copayment may be stored in a storage device 110 or determined by the benefit manager device 102.

In some instances, the member may not pay the copayment or may only pay a portion of the copayment for the prescription drug. For example, if a usual and customary cost for a generic version of a prescription drug is $4, and the member's flat copayment is $20 for the prescription drug, the member may only need to pay $4 to receive the prescription drug. In another example involving a worker's compensation claim, no copayment may be due by the member for the prescription drug.

In addition, copayments may also vary based on different delivery channels for the prescription drug. For example, the copayment for receiving the prescription drug from a mail order pharmacy location may be less than the copayment for receiving the prescription drug from a retail pharmacy location.

In conjunction with receiving a copayment (if any) from the member and dispensing the prescription drug to the member, the pharmacy submits a claim to the PBM for the prescription drug. After receiving the claim, the PBM (such as by using the benefit manager device 102) may perform certain adjudication operations including verifying eligibility for the member, identifying/reviewing an applicable formulary for the member to determine any appropriate copayment, coinsurance, and deductible for the prescription drug, and performing a drug utilization review (DUR) for the member. Further, the PBM may provide a response to the pharmacy (for example, the pharmacy system 100) following performance of at least some of the aforementioned operations.

As part of the adjudication, a plan sponsor (or the PBM on behalf of the plan sponsor) ultimately reimburses the pharmacy for filling the prescription drug when the prescription drug was successfully adjudicated. The aforementioned adjudication operations generally occur before the copayment is received and the prescription drug is dispensed. However in some instances, these operations may occur simultaneously, substantially simultaneously, or in a different order. In addition, more or fewer adjudication operations may be performed as at least part of the adjudication process.

The amount of reimbursement paid to the pharmacy by a plan sponsor and/or money paid by the member may be determined at least partially based on types of pharmacy networks in which the pharmacy is included. In some implementations, the amount may also be determined based on other factors. For example, if the member pays the pharmacy for the prescription drug without using the prescription or drug benefit provided by the PBM, the amount of money paid by the member may be higher than when the member uses the prescription or drug benefit. In some implementations, the amount of money received by the pharmacy for dispensing the prescription drug and for the prescription drug itself may be higher than when the member uses the prescription or drug benefit. Some or all of the foregoing operations may be performed by executing instructions stored in the benefit manager device 102 and/or an additional device.

Examples of the network 104 include a Global System for Mobile Communications (GSM) network, a code division multiple access (CDMA) network, 3rd Generation Partnership Project (3GPP), an Internet Protocol (IP) network, a Wireless Application Protocol (WAP) network, or an IEEE 802.11 standards network, as well as various combinations of the above networks. The network 104 may include an optical network. The network 104 may be a local area network or a global communication network, such as the Internet. In some implementations, the network 104 may include a network dedicated to prescription orders: a prescribing network such as the electronic prescribing network operated by Surescripts of Arlington, Virginia.

Moreover, although the system shows a single network 104, multiple networks can be used. The multiple networks may communicate in series and/or parallel with each other to link the devices 102-110.

The pharmacy device 106 may be a device associated with a retail pharmacy location (e.g., an exclusive pharmacy location, a grocery store with a retail pharmacy, or a general sales store with a retail pharmacy) or other type of pharmacy location at which a member attempts to obtain a prescription. The pharmacy may use the pharmacy device 106 to submit the claim to the PBM for adjudication.

Additionally, in some implementations, the pharmacy device 106 may enable information exchange between the pharmacy and the PBM. For example, this may allow the sharing of member information such as drug history that may allow the pharmacy to better service a member (for example, by providing more informed therapy consultation and drug interaction information). In some implementations, the benefit manager device 102 may track prescription drug fulfillment and/or other information for users that are not members, or have not identified themselves as members, at the time (or in conjunction with the time) in which they seek to have a prescription filled at a pharmacy.

The pharmacy device 106 may include a pharmacy fulfillment device 112, an order processing device 114, and a pharmacy management device 116 in communication with each other directly and/or over the network 104. The order processing device 114 may receive information regarding filling prescriptions and may direct an order component to one or more devices of the pharmacy fulfillment device 112 at a pharmacy. The pharmacy fulfillment device 112 may fulfill, dispense, aggregate, and/or pack the order components of the prescription drugs in accordance with one or more prescription orders directed by the order processing device 114.

In general, the order processing device 114 is a device located within or otherwise associated with the pharmacy to enable the pharmacy fulfillment device 112 to fulfill a prescription and dispense prescription drugs. In some implementations, the order processing device 114 may be an external order processing device separate from the pharmacy and in communication with other devices located within the pharmacy.

For example, the external order processing device may communicate with an internal pharmacy order processing device and/or other devices located within the system 100. In some implementations, the external order processing device may have limited functionality (e.g., as operated by a user requesting fulfillment of a prescription drug), while the internal pharmacy order processing device may have greater functionality (e.g., as operated by a pharmacist).

The order processing device 114 may track the prescription order as it is fulfilled by the pharmacy fulfillment device 112. The prescription order may include one or more prescription drugs to be filled by the pharmacy. The order processing device 114 may make pharmacy routing decisions and/or order consolidation decisions for the particular prescription order. The pharmacy routing decisions include what device(s) in the pharmacy are responsible for filling or otherwise handling certain portions of the prescription order. The order consolidation decisions include whether portions of one prescription order or multiple prescription orders should be shipped together for a user or a user family. The order processing device 114 may also track and/or schedule literature or paperwork associated with each prescription order or multiple prescription orders that are being shipped together. In some implementations, the order processing device 114 may operate in combination with the pharmacy management device 116.

The order processing device 114 may include circuitry, a processor, a memory to store data and instructions, and communication functionality. The order processing device 114 is dedicated to performing processes, methods, and/or instructions described in this application. Other types of electronic devices may also be used that are specifically configured to implement the processes, methods, and/or instructions described in further detail below.

In some implementations, at least some functionality of the order processing device 114 may be included in the pharmacy management device 116. The order processing device 114 may be in a client-server relationship with the pharmacy management device 116, in a peer-to-peer relationship with the pharmacy management device 116, or in a different type of relationship with the pharmacy management device 116. The order processing device 114 and/or the pharmacy management device 116 may communicate directly (for example, such as by using a local storage) and/or through the network 104 (such as by using a cloud storage configuration, software as a service, etc.) with the storage device 110.

The storage device 110 may include: non-transitory storage (for example, memory, hard disk, CD-ROM, etc.) in communication with the benefit manager device 102 and/or the pharmacy device 106 directly and/or over the network 104. The non-transitory storage may store order data 118, member data 120, claims data 122, drug data 124, prescription data 126, and/or plan sponsor data 128. Further, the system 100 may include additional devices, which may communicate with each other directly or over the network 104.

The order data 118 may be related to a prescription order. The order data may include type of the prescription drug (for example, drug name and strength) and quantity of the prescription drug. The order data 118 may also include data used for completion of the prescription, such as prescription materials. In general, prescription materials include an electronic copy of information regarding the prescription drug for inclusion with or otherwise in conjunction with the fulfilled prescription. The prescription materials may include electronic information regarding drug interaction warnings, recommended usage, possible side effects, expiration date, date of prescribing, etc. The order data 118 may be used by a high-volume fulfillment center to fulfill a pharmacy order.

In some implementations, the order data 118 includes verification information associated with fulfillment of the prescription in the pharmacy. For example, the order data 118 may include videos and/or images taken of (i) the prescription drug prior to dispensing, during dispensing, and/or after dispensing, (ii) the prescription container (for example, a prescription container and sealing lid, prescription packaging, etc.) used to contain the prescription drug prior to dispensing, during dispensing, and/or after dispensing, (iii) the packaging and/or packaging materials used to ship or otherwise deliver the prescription drug prior to dispensing, during dispensing, and/or after dispensing, and/or (iv) the fulfillment process within the pharmacy. Other types of verification information such as barcode data read from pallets, bins, trays, or carts used to transport prescriptions within the pharmacy may also be stored as order data 118.

The member data 120 includes information regarding the members associated with the PBM. The information stored as member data 120 may include personal information, personal health information, protected health information, etc. Examples of the member data 120 include name, age, date of birth, address (including city, state, and zip code), telephone number, e-mail address, medical history, prescription drug history, etc. In various implementations, the prescription drug history may include a prior authorization claim history including the total number of prior authorization claims, approved prior authorization claims, and denied prior authorization claims. In various implementations, the prescription drug history may include previously filled claims for the member, including a date of each filled claim, a dosage of each filled claim, the drug type for each filled claim, a prescriber associated with each filled claim, and whether the drug associated with each claim is on a formulary (e.g., a list of covered medication).

In various implementations, the medical history may include whether and/or how well each member adhered to one or more specific therapies. The member data 120 may also include a plan sponsor identifier that identifies the plan sponsor associated with the member and/or a member identifier that identifies the member to the plan sponsor. The member data 120 may include a member identifier that identifies the plan sponsor associated with the user and/or a user identifier that identifies the user to the plan sponsor. In various implementations, the member data 120 may include an eligibility period for each member. For example, the eligibility period may include how long each member is eligible for coverage under the sponsored plan. The member data 120 may also include dispensation preferences such as type of label, type of cap, message preferences, language preferences, etc.

The member data 120 may be accessed by various devices in the pharmacy (for example, the high-volume fulfillment center, etc.) to obtain information used for fulfillment and shipping of prescription orders. In some implementations, an external order processing device operated by or on behalf of a member may have access to at least a portion of the member data 120 for review, verification, or other purposes.

In some implementations, the member data 120 may include information for persons who are users of the pharmacy but are not members in the pharmacy benefit plan being provided by the PBM. For example, these users may obtain drugs directly from the pharmacy, through a private label service offered by the pharmacy, the high-volume fulfillment center, or otherwise. In general, the terms “member” and “user” may be used interchangeably.

The claims data 122 includes information regarding pharmacy claims adjudicated by the PBM under a drug benefit program provided by the PBM for one or more plan sponsors. In general, the claims data 122 includes an identification of the client that sponsors the drug benefit program under which the claim is made, and/or the member that purchased the prescription drug giving rise to the claim, the prescription drug that was filled by the pharmacy (e.g., the national drug code number, etc.), the dispensing date, generic indicator, generic product identifier (GPI) number, medication class, the cost of the prescription drug provided under the drug benefit program, the copayment/coinsurance amount, rebate information, and/or member eligibility, etc. Additional information may be included.

In some implementations, other types of claims beyond prescription drug claims may be stored in the claims data 122. For example, medical claims, dental claims, wellness claims, or other types of health-care-related claims for members may be stored as a portion of the claims data 122.

In some implementations, the claims data 122 includes claims that identify the members with whom the claims are associated. Additionally or alternatively, the claims data 122 may include claims that have been de-identified (that is, associated with a unique identifier but not with a particular, identifiable member). In various implementations, the claims data 122 may include a percentage of prior authorization cases for each prescriber that have been denied, and a percentage of prior authorization cases for each prescriber that have been approved.

The drug data 124 may include drug name (e.g., technical name and/or common name), other names by which the drug is known, active ingredients, an image of the drug (such as in pill form), etc. The drug data 124 may include information associated with a single medication or multiple medications. For example, the drug data 124 may include a numerical identifier for each drug, such as the U.S. Food and Drug Administration's (FDA) National Drug Code (NDC) for each drug.

The prescription data 126 may include information regarding prescriptions that may be issued by prescribers on behalf of users, who may be members of the pharmacy benefit plan—for example, to be filled by a pharmacy.

Examples of the prescription data 126 include user names, medication or treatment (such as lab tests), dosing information, etc. The prescriptions may include electronic prescriptions or paper prescriptions that have been scanned. In some implementations, the dosing information reflects a frequency of use (e.g., once a day, twice a day, before each meal, etc.) and a duration of use (e.g., a few days, a week, a few weeks, a month, etc.).

In some implementations, the order data 118 may be linked to associated member data 120, claims data 122, drug data 124, and/or prescription data 126.

The plan sponsor data 128 includes information regarding the plan sponsors of the PBM. Examples of the plan sponsor data 128 include company name, company address, contact name, contact telephone number, contact e-mail address, etc.

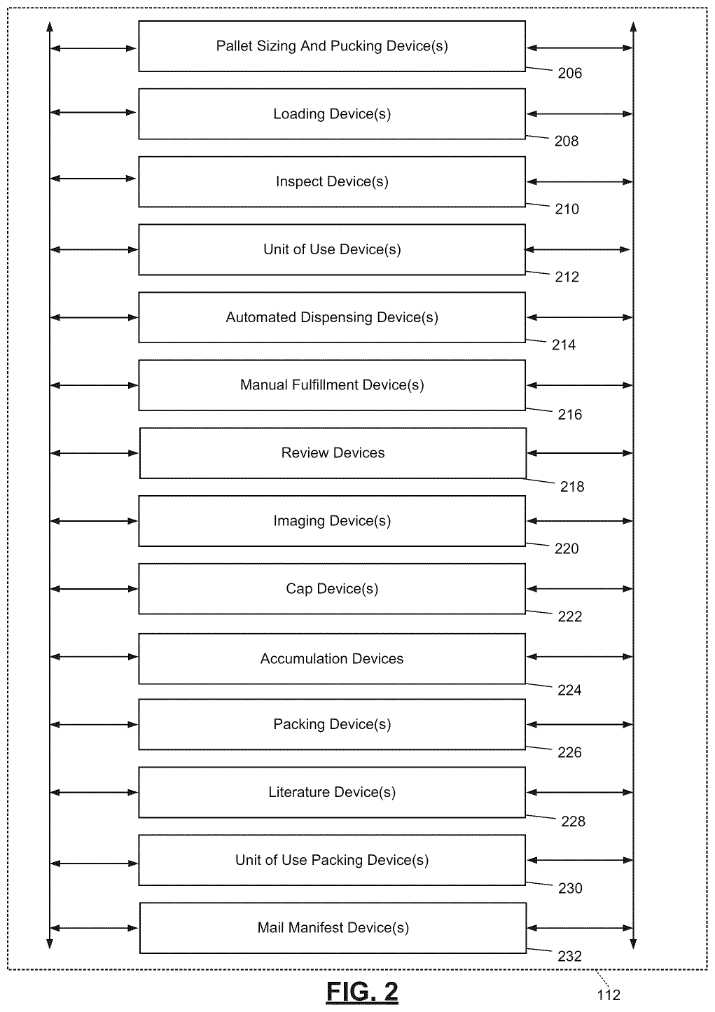

FIG. 2 illustrates the pharmacy fulfillment device 112 according to an example implementation. The pharmacy fulfillment device 112 may be used to process and fulfill prescriptions and prescription orders. After fulfillment, the fulfilled prescriptions are packed for shipping.

The pharmacy fulfillment device 112 may include devices in communication with the benefit manager device 102, the order processing device 114, and/or the storage device 110, directly or over the network 104. Specifically, the pharmacy fulfillment device 112 may include pallet sizing and pucking device(s) 206, loading device(s) 208, inspect device(s) 210, unit of use device(s) 212, automated dispensing device(s) 214, manual fulfillment device(s) 216, review devices 218, imaging device(s) 220, cap device(s) 222, accumulation devices 224, packing device(s) 226, literature device(s) 228, unit of use packing device(s) 230, and mail manifest device(s) 232. Further, the pharmacy fulfillment device 112 may include additional devices, which may communicate with each other directly or over the network 104.

In some implementations, operations performed by one of these devices 206-232 may be performed sequentially, or in parallel with the operations of another device as may be coordinated by the order processing device 114. In some implementations, the order processing device 114 tracks a prescription with the pharmacy based on operations performed by one or more of the devices 206-232.

In some implementations, the pharmacy fulfillment device 112 may transport prescription drug containers, for example, among the devices 206-232 in the high-volume fulfillment center, by use of pallets. The pallet sizing and pucking device 206 may configure pucks in a pallet. A pallet may be a transport structure for a number of prescription containers, and may include a number of cavities. A puck may be placed in one or more than one of the cavities in a pallet by the pallet sizing and pucking device 206. The puck may include a receptacle sized and shaped to receive a prescription container. Such containers may be supported by the pucks during carriage in the pallet. Different pucks may have differently sized and shaped receptacles to accommodate containers of differing sizes, as may be appropriate for different prescriptions.

The arrangement of pucks in a pallet may be determined by the order processing device 114 based on prescriptions that the order processing device 114 decides to launch. The arrangement logic may be implemented directly in the pallet sizing and pucking device 206. Once a prescription is set to be launched, a puck suitable for the appropriate size of container for that prescription may be positioned in a pallet by a robotic arm or pickers. The pallet sizing and pucking device 206 may launch a pallet once pucks have been configured in the pallet.

The loading device 208 may load prescription containers into the pucks on a pallet by a robotic arm, a pick and place mechanism (also referred to as pickers), etc. In various implementations, the loading device 208 has robotic arms or pickers to grasp a prescription container and move it to and from a pallet or a puck. The loading device 208 may also print a label that is appropriate for a container that is to be loaded onto the pallet, and apply the label to the container. The pallet may be located on a conveyor assembly during these operations (e.g., at the high-volume fulfillment center, etc.).

The inspect device 210 may verify that containers in a pallet are correctly labeled and in the correct spot on the pallet. The inspect device 210 may scan the label on one or more containers on the pallet. Labels of containers may be scanned or imaged in full or in part by the inspect device 210. Such imaging may occur after the container has been lifted out of its puck by a robotic arm, picker, etc., or may be otherwise scanned or imaged while retained in the puck. In some implementations, images and/or video captured by the inspect device 210 may be stored in the storage device 110 as order data 118.

The unit of use device 212 may temporarily store, monitor, label, and/or dispense unit of use products. In general, unit of use products are prescription drug products that may be delivered to a user or member without being repackaged at the pharmacy. These products may include pills in a container, pills in a blister pack, inhalers, etc. Prescription drug products dispensed by the unit of use device 212 may be packaged individually or collectively for shipping, or may be shipped in combination with other prescription drugs dispensed by other devices in the high-volume fulfillment center.

At least some of the operations of the devices 206-232 may be directed by the order processing device 114. For example, the manual fulfillment device 216, the review device 218, the automated dispensing device 214, and/or the packing device 226, etc. may receive instructions provided by the order processing device 114.

The automated dispensing device 214 may include one or more devices that dispense prescription drugs or pharmaceuticals into prescription containers in accordance with one or multiple prescription orders. In general, the automated dispensing device 214 may include mechanical and electronic components with, in some implementations, software and/or logic to facilitate pharmaceutical dispensing that would otherwise be performed in a manual fashion by a pharmacist and/or pharmacist technician. For example, the automated dispensing device 214 may include high-volume fillers that fill a number of prescription drug types at a rapid rate and blister pack machines that dispense and pack drugs into a blister pack. Prescription drugs dispensed by the automated dispensing devices 214 may be packaged individually or collectively for shipping, or may be shipped in combination with other prescription drugs dispensed by other devices in the high-volume fulfillment center.

The manual fulfillment device 216 controls how prescriptions are manually fulfilled. For example, the manual fulfillment device 216 may receive or obtain a container and enable fulfillment of the container by a pharmacist or pharmacy technician. In some implementations, the manual fulfillment device 216 provides the filled container to another device in the pharmacy fulfillment devices 112 to be joined with other containers in a prescription order for a user or member.

In general, manual fulfillment may include operations at least partially performed by a pharmacist or a pharmacy technician. For example, a person may retrieve a supply of the prescribed drug, may make an observation, may count out a prescribed quantity of drugs and place them into a prescription container, etc. Some portions of the manual fulfillment process may be automated by use of a machine. For example, counting of capsules, tablets, or pills may be at least partially automated (such as through use of a pill counter). Prescription drugs dispensed by the manual fulfillment device 216 may be packaged individually or collectively for shipping, or may be shipped in combination with other prescription drugs dispensed by other devices in the high-volume fulfillment center.

The review device 218 may process prescription containers to be reviewed by a pharmacist for proper pill count, exception handling, prescription verification, etc. Fulfilled prescriptions may be manually reviewed and/or verified by a pharmacist, as may be required by state or local law. A pharmacist or other licensed pharmacy person who may dispense certain drugs in compliance with local and/or other laws may operate the review device 218 and visually inspect a prescription container that has been filled with a prescription drug. The pharmacist may review, verify, and/or evaluate drug quantity, drug strength, and/or drug interaction concerns, or otherwise perform pharmacist services. The pharmacist may also handle containers which have been flagged as an exception, such as containers with unreadable labels, containers for which the associated prescription order has been canceled, containers with defects, etc. In an example, the manual review can be performed at a manual review station.

The imaging device 220 may image containers once they have been filled with pharmaceuticals. The imaging device 220 may measure a fill height of the pharmaceuticals in the container based on the obtained image to determine if the container is filled to the correct height given the type of pharmaceutical and the number of pills in the prescription. Images of the pills in the container may also be obtained to detect the size of the pills themselves and markings thereon. The images may be transmitted to the order processing device 114 and/or stored in the storage device 110 as part of the order data 118.

The cap device 222 may be used to cap or otherwise seal a prescription container. In some implementations, the cap device 222 may secure a prescription container with a type of cap in accordance with a user preference (e.g., a preference regarding child resistance, etc.), a plan sponsor preference, a prescriber preference, etc. The cap device 222 may also etch a message into the cap, although this process may be performed by a subsequent device in the high-volume fulfillment center.

The accumulation device 224 accumulates various containers of prescription drugs in a prescription order. The accumulation device 224 may accumulate prescription containers from various devices or areas of the pharmacy.

For example, the accumulation device 224 may accumulate prescription containers from the unit of use device 212, the automated dispensing device 214, the manual fulfillment device 216, and the review device 218. The accumulation device 224 may be used to group the prescription containers prior to shipment to the member.

The literature device 228 prints, or otherwise generates, literature to include with each prescription drug order. The literature may be printed on multiple sheets of substrates, such as paper, coated paper, printable polymers, or combinations of the above substrates. The literature printed by the literature device 228 may include information required to accompany the prescription drugs included in a prescription order, other information related to prescription drugs in the order, financial information associated with the order (for example, an invoice or an account statement), etc.

In some implementations, the literature device 228 folds or otherwise prepares the literature for inclusion with a prescription drug order (e.g., in a shipping container). In other implementations, the literature device 228 prints the literature and is separate from another device that prepares the printed literature for inclusion with a prescription order.

The packing device 226 packages the prescription order in preparation for shipping the order. The packing device 226 may box, bag, or otherwise package the fulfilled prescription order for delivery. The packing device 226 may further place inserts (e.g., literature or other papers, etc.) into the packaging received from the literature device 228. For example, bulk prescription orders may be shipped in a box, while other prescription orders may be shipped in a bag, which may be a wrap seal bag.

The packing device 226 may label the box or bag with an address and a recipient's name. The label may be printed and affixed to the bag or box, be printed directly onto the bag or box, or otherwise associated with the bag or box. The packing device 226 may sort the box or bag for mailing in an efficient manner (e.g., sort by delivery address, etc.). The packing device 226 may include ice or temperature sensitive elements for prescriptions that are to be kept within a temperature range during shipping (for example, this may be necessary in order to retain efficacy). The ultimate package may then be shipped through postal mail, through a mail order delivery service that ships via ground and/or air (e.g., UPS, FEDEX, or DHL, etc.), through a delivery service, through a locker box at a shipping site (e.g., AMAZON locker or a PO Box, etc.), or otherwise.

The unit of use packing device 230 packages a unit of use prescription order in preparation for shipping the order. The unit of use packing device 230 may include manual scanning of containers to be bagged for shipping to verify each container in the order. In an example implementation, the manual scanning may be performed at a manual scanning station. The pharmacy fulfillment device 112 may also include a mail manifest device 232 to print mailing labels used by the packing device 226 and may print shipping manifests and packing lists.

While the pharmacy fulfillment device 112 in FIG. 2 is shown to include single devices 206-232, multiple devices may be used. When multiple devices are present, the multiple devices may be of the same device type or models, or may be a different device type or model. The types of devices 206-232 shown in FIG. 2 are example devices. In other configurations of the system 100, lesser, additional, or different types of devices may be included.

Moreover, multiple devices may share processing and/or memory resources. The devices 206-232 may be located in the same area or in different locations. For example, the devices 206-232 may be located in a building or set of adjoining buildings. The devices 206-232 may be interconnected (such as by conveyors), networked, and/or otherwise in contact with one another or integrated with one another (e.g., at the high-volume fulfillment center, etc.). In addition, the functionality of a device may be split among a number of discrete devices and/or combined with other devices.

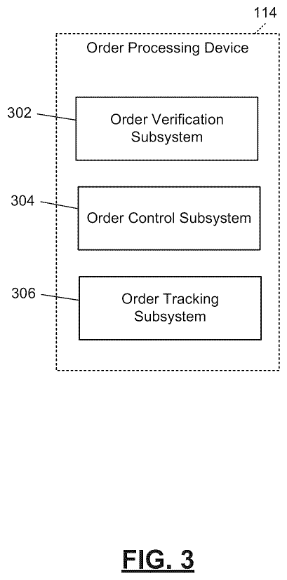

FIG. 3 illustrates the order processing device 114 according to an example implementation. The order processing device 114 may be used by one or more operators to generate prescription orders, make routing decisions, make prescription order consolidation decisions, track literature with the system 100, and/or view order status and other order related information. For example, the prescription order may be comprised of order components.

The order processing device 114 may receive instructions to fulfill an order without operator intervention. An order component may include a prescription drug fulfilled by use of a container through the system 100. The order processing device 114 may include an order verification subsystem 302, an order control subsystem 304, and/or an order tracking subsystem 306. Other subsystems may also be included in the order processing device 114.

The order verification subsystem 302 may communicate with the benefit manager device 102 to verify the eligibility of the member and review the formulary to determine appropriate copayment, coinsurance, and deductible for the prescription drug and/or perform a DUR (drug utilization review). Other communications between the order verification subsystem 302 and the benefit manager device 102 may be performed for a variety of purposes.

The order control subsystem 304 controls various movements of the containers and/or pallets along with various filling functions during their progression through the system 100. In some implementations, the order control subsystem 304 may identify the prescribed drug in one or more than one prescription orders as capable of being fulfilled by the automated dispensing device 214. The order control subsystem 304 may determine which prescriptions are to be launched and may determine that a pallet of automated-fill containers is to be launched.

The order control subsystem 304 may determine that an automated-fill prescription of a specific pharmaceutical is to be launched and may examine a queue of orders awaiting fulfillment for other prescription orders, which will be filled with the same pharmaceutical. The order control subsystem 304 may then launch orders with similar automated-fill pharmaceutical needs together in a pallet to the automated dispensing device 214. As the devices 206-232 may be interconnected by a system of conveyors or other container movement systems, the order control subsystem 304 may control various conveyors: for example, to deliver the pallet from the loading device 208 to the manual fulfillment device 216 from the literature device 228, paperwork as needed to fill the prescription.

The order tracking subsystem 306 may track a prescription order during its progress toward fulfillment. The order tracking subsystem 306 may track, record, and/or update order history, order status, etc. The order tracking subsystem 306 may store data locally (for example, in a memory) or as a portion of the order data 118 stored in the storage device 110.

### Compression System

Sets of logical rules may be created to define relationships between entities so that computers can process these relationships. For example, medical pricing contracts between medical service providers and insurance companies or other third-party payers may be defined as a set of computer-processable rules because they are too complex for human administration. For example, these contracts may specify the payment rates and/or payment discounts for medical services and procedures. A rule may be in the form of a Boolean algebraic expression. Some contracts include more than a hundred thousand rules.

On a recurring basis (for example, annually), a medical service provider and an insurance company may negotiate to modify the pricing terms of a contract. During these negotiations, the parties will often run simulations to determine the value of an updated contract, which may include applying the rules of an existing contract to a set of claim records from a user-selected time period. Due to the number and complexity of the rules contained in the existing contract, simulations may often take a substantial amount of time (for example, days) to generate an output, which severely delays the negotiations and increases associated costs (e.g., energy costs for the computing devices running the simulations, etc.).

Returning to FIG. 1, the system 100 may include a compression system 400 capable of compressing uncompressed and/or existing contracts (e.g., medical pricing contracts) to produce compressed contracts. More specifically, the compression system 400 is capable of compressing (e.g., reducing, combining, simplifying, and/or eliminating) rules of a contract to produce a compressed contract.

In comparison with uncompressed contracts, compressed contracts are associated with reduced contract processing times and/or reduced contract file sizes. For instance, simulations that use compressed contracts are capable of being completed substantially quicker in comparison with simulations that use uncompressed and/or existing contracts. In some instances, simulations that use compressed contracts evidence a reduction in rule processing time of approximately 90%.

In various implementations, simulations that are configured to determine one or more values (e.g., profit, revenue, etc.) associated with a compressed contract are capable of being completed quickly and efficiently so that contract negotiations (e.g., between a medical service provider and an insurance company) are capable of being completed in real-time that is, without observable delays caused from simulation runtimes. Also, computing devices that execute simulations that use compressed contracts consume less power resulting in a reduction in energy costs. Further, in comparison with an uncompressed contract, a compressed contract may require less storage space and therefore less bandwidth during operations such as syncing or updating.

Contracts are created by users (e.g., contractors) and are inherently complex, inefficient, and/or large. For instance, some contracts include intricate nested rules, repeated rules, unnecessary rules, and/or a substantial number of rules (e.g., at least a hundred thousand rules). A rule may be in the form of a Boolean algebraic expression including a set of conditions that can be logically tested and a set of actions to take if the set of conditions is met.

The following example includes an uncompressed rule from a medical pricing contract. The uncompressed rule includes a set of nested conditions. The example is provided in a JavaScript Object Notation (JSON) format. The rule sets a discount of 50% for medical services or procedures with modifiers 25, 26, or 27.

```
“rules”: {
  “op_services”: [
  {
    “conditions”: {
      “all”: [
        {
        “any”: [
        {
          “value”: [
            “25”
          ],
          “operator”: “in_list”,
        },
        {
          “value”: [
            “26”
          ],
          “operator”: “in_list”,
        },
        {
          “value”: [
            “27”
          “operator”: “in_list”,
        }
      ]
    },
    “actions”: [
      {
        “params”: {
          “percent”: 50
        }
      }
    ]
}
```

In the above example, the conditions of the rule must be satisfied for the action of the rule to be executed. Specifically, in response to the modifier value of the medical service or procedure being in a list of values (25, 26, or 27) for a determined category of medical services (for example, E&M Preventive Services), a discount of 50% will be applied to the price of the medical service or procedure.

E&M preventive services refer to preventive medical services provided by healthcare providers, which are covered under the E&M codes of the Current Procedural Terminology (CPT) code set. These services are intended to help prevent illnesses, diseases, and/or injuries and promote overall health and wellness in patients.

In medical billing and coding, a modifier may be a two-digit code that is added to a Healthcare Common Procedure Coding System (HCPCS) or a CPT code to provide additional information about the service or procedure that was performed. A modifier may be used to indicate that a service was provided on a different day than usual and/or that it was performed on a different anatomical site, etc. Modifier 25 may be used to indicate that a significant, separately identifiable E&M service was provided on the same day as a procedure or other medical service. This allows the service provider to bill for both the procedure and the E&M service. Modifier 26 may be used to indicate that only the professional component of a diagnostic test was provided, such as when a radiologist interprets an x-ray but does not perform the actual test. Modifier 27 may be used to indicate that multiple outpatient hospital E&M services occurred on the same day.

In some instances, an insurance company may apply the agreed-upon discount rates to the agreed-upon list prices of the medical services or procedures included in a rate sheet when processing patient medical claims. A rate sheet is a document that outlines the prices or rates for various medical services or procedures provided by a healthcare provider or facility. A rate sheet may be used in connection with and/or may be included in a medical pricing contract. In some examples, the rates of a rate sheet may include the charges for services such as diagnostic tests, consultations, surgeries, and other medical treatments. Rate sheets may be used by healthcare providers to communicate their prices to patients, insurance companies, and/or other third-party payers. Insurance companies may use rate sheets to determine how much they will reimburse healthcare providers for specific services, and patients may use them to understand the cost of care and make informed decisions about their healthcare. Rate sheets are often updated regularly to reflect changes in pricing or to add new services as they become available. Some healthcare providers may also negotiate rates with insurance companies or offer discounted rates for certain services to help make healthcare more affordable for their patients.

In the above example, the id may refer to a unique identifier for the rate sheet used by the rule. The rate sheet code may refer to code that identifies the rate sheet that applies to a group of health care providers and facilities for a certain time period. The provider ids may refer to an array of unique identifiers for the healthcare facilities associated with the rate sheet. The facility entity ids may refer to the healthcare providers associated with the rate sheet. The lines of business may refer to an object that maps lines of business to arrays of provider IDs. The chargemaster may refer to a chargemaster used by the rule and/or an object that specifies the percentage discount that should be applied to charges of the chargemaster. The fee schedule type may refer to the type of fee schedule associated with the rate sheet.

The effective date may refer to the date when the rate sheet becomes effective. The end date may refer to the date when the rate sheet expires. The title may refer the title of the rate sheet and may include the rate sheet code, effective date, and the end date. The source type may refer to the type of source used to generate the rate sheet. The year applied may refer to the year when the rate sheet was applied. The rate sheet rules id may refer to the unique identifier for the rate sheet rules associated with the rate sheet. The rate sheet category may refer to the category of the rate sheet. The manual stop loss may refer to whether or not a manual stop loss is applied to the rate sheet. The rules may specify the rules associated with the rate sheet (e.g., op services rules that apply to outpatient services).

The above uncompressed rule may be compressed via the compression system 400 such to generate the following sample compressed rule.

```
“rules”: {
  “op_services”: [
    {
      “conditions”: {
        “any”: [
          {
            “value”: [
              “25”,
              “26”,
              “27”
            “operator”: “in_list”,
          }
        ]
      },
    “actions”: [
      {
        “params”: {
        “percent”: 50
      }
    }
  ]
}
```

As shown above, the conditions portion of the compressed rule has been reduced and simplified in comparison with the conditions portion of the uncompressed rule. More specifically, the logical ANY operator including its elements have been promoted and the unnecessary logical ALL operator has been eliminated. Also, the elements of the logical ANY operator have been consolidated such that repeated lines of code are removed. When the uncompressed rule and the compressed rule are applied to an identical set of claim data, the rules are capable of producing the same output; however, the compressed rule is capable of producing the output quicker.

As another example of a condition, consider the simplified situation of values A, B, C, D, E, and F, combined using the following Boolean operators:

```
{
  ‘all’: [
    {
      ‘any’: [
        A,
        B,
        {
          ‘all’: [
            C,
            D
          ]
        },
        {
          ‘any’: [
            E,
            F
          ]
        }
      ]
    }
  ]
}
```

This condition can be logically simplified according to the principles of the present disclosure. In various implementations, the condition can be compressed into the following representation:

```
{
  ‘any’: [
    A,
    B,
    {
      ‘all’: [
        C,
        D
      ]
    },
    E,
    F
  ]
}
```

Note that this compressed format can be directly used to test for the condition—there is no need to retain the uncompressed version or to un-compress at the time of testing the condition.

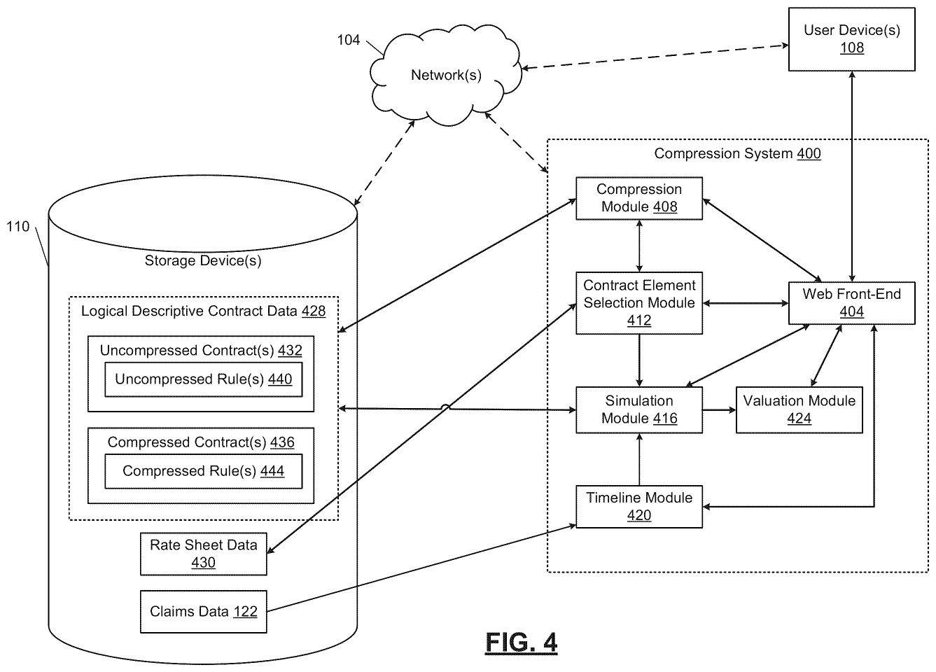

FIG. 4 is a functional block diagram of an example compression system 400. As shown in FIG. 4, the compression system 400 may include a web front-end 404 (e.g., a user interface), a compression module 408, a contract element selection module 412, a simulation module 416, a timeline module 420, and a valuation module 424. In various implementations, one or more components of the compression system 400 may be suitable for communicating with other components of the system 100 over the network 104. For instance, one or more components of the compression system 400 may communicate with the user device 108 and/or the storage device 110.

As illustrated in FIG. 4, a storage device 110 includes claims data 122, logical descriptive contract data 428, and rate sheet data 430. The logical descriptive contract data 428 may include one or more uncompressed contracts 432 and one or more compressed contracts 436. An uncompressed contract 432 includes uncompressed rules 440 and/or a compressed contract 436 includes compressed and/or fully optimized rules 444. In some example configurations, the rata sheet data 430 may be included in the logical descriptive contract data 428.

The modules of the compression system 400 (e.g., the compression module 408, the contract element selection module 412, the simulation module 416, the timeline module 420, and the valuation module 424) may be operatively coupled to the web front-end 404 and/or operatively coupled to each other. The modules may be software modules stored on non-transitory computer-readable storage media, such as system storage and/or the one or more data stores of the system 100. In some example configurations, one or more processors of a user device 108 may be configured to execute the instructions of the modules of the compression system 400. In some implementations, a user may operate the compression module 408, the contract element selection module 412, the simulation module 416, the timeline module 420, and/or the valuation module 424 via the web front-end 404.

In various implementations, the compression module 408 may be configured to compress an uncompressed contract 432 to generate a compressed contract 436 in accordance with the principles of the present disclosure. In various implementations, a user may select, modify, update, add, and/or remove contract elements and/or terms via the web front-end 404 and/or the contract element selection module 412. In some examples, the contract elements and/or terms may include rate sheet data 430. For instance, a user may select a rate sheet to be used for a simulation via the web front-end 404 and/or a user may modify the elements of a rate sheet to generate an updated rate sheet that may be used for a simulation via the web front-end 404.

In various implementations, a user may select claims data 122 to be used in a simulation via the web front-end 404 and/or the timeline module 420. For instance, a user may select medical claim data including the medical service or procedure performed, the time period of when the service or procedure was performed, and/or the medical service provider who performed the service or procedure via the web front-end 404.

The simulation module 416 may be configured to execute various simulations. In some instances, a simulation may use logical descriptive contract data 428, claims data 122, and/or rate sheet data 430 to generate a simulation output. The valuation module 424 may be configured to generate valuation values associated with one or more simulations and/or one or more contracts.

In one example, a user (e.g., a health insurance company) may run a simulation to determine the amount of revenue and/or profit a certain contract (e.g., a medical pricing contract) will generate when the rules of the contract are applied to medical claim data and rate sheet data selected by the user. The contract may be in the form of an uncompressed contract 432 or a compressed contact 436. A simulation that uses an uncompressed contract 432 may produce the same output as a simulation that uses a compressed version of the uncompressed contract 432 (e.g., a compressed contract 436); however, the simulation that uses the compressed contract 436 is capable of being completed substantially quicker in comparison with the simulation that uses the uncompressed contract 432.

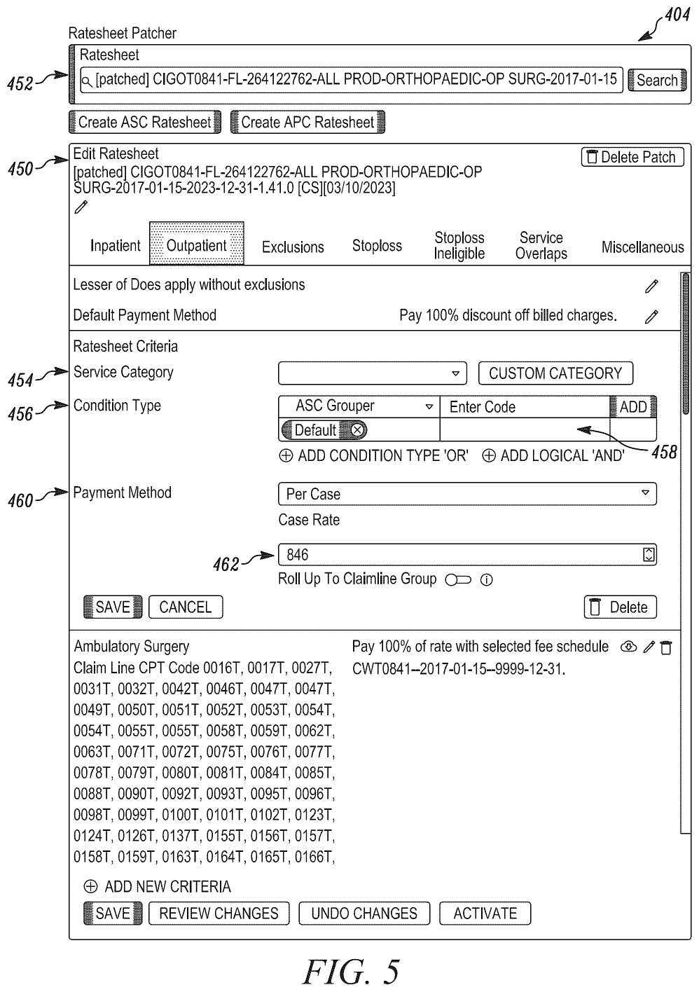

FIG. 5 is an example of a web front-end 404 that a user may use to select, modify, update, add, and/or remove contract elements and/or terms of a contract. In some examples, the contract elements and/or terms may include elements and/or terms of a rate sheet. A user may also be able to create a new rate sheet via the web front-end 404.

In some example configurations, the web front-end 404 may include a rate sheet criteria selection 450. The rate sheet criteria selection 450 may permit a user to select, modify, update, add, and/or remove elements and/or terms of a rate sheet (e.g., rate sheet data 430). The rate sheet criteria selection 450 may include a service provider selection portion 452, a service category selection portion 454, a condition type selection portion 456, a serve code selection portion 458, a payment method selection portion 460, and/or a payment amount selection portion 462, among others.

In various implementations, the service provider selection portion 452 may permit a user to select a preexisting rate sheet of or generate a new rate sheet for a certain medical service provider. The service category selection portion 454 may permit a user to select and/or modify service category elements of a rate sheet. For example and without limitation, a service category may include an inpatient service category and/or an outpatient service category, among others. The condition type selection portion 456 may permit a user to select and/or modify condition type elements of a rate sheet. For example and without limitation, a condition type may include an Ambulatory Surgical Center (ASC) grouper condition type. An ASC may include medical facilities where surgery that does not require hospital admissions is performed (e.g., cataracts, colonoscopies, and/or arthroscopic surgeries, etc.).

The service code selection portion 458 may permit a user to select and/or modify the service code elements of a rate sheet. A service code may include the unique identifier code of a specific medical service or procedure. The payment method selection portion 460 may permit a user to select and/or modify the payment method elements of a rate sheet. A payment method selection may include a per-case selection. The payment amount selection portion 462 may permit a user to select and/or modify the payment amount elements of a rate sheet. A user may select the dollar amount of a medical service or produce (e.g., the case rate).

In various implementations, in response to a user modifying and/or updating one or more contract elements and/or terms (e.g., rate sheet elements and/or terms) of an existing contract, the compression system 400 is configured to automatically generate a compressed version of the uncompressed contract that is, a compressed contract. The compression system 400 is configured to function transparently to the user. In various implementations, the compression system 400 may operate to compress a rule every time a modification or update is made; in other implementations, or dependent on a configuration setting, the compression system 400 may perform compression tasks on a batch basis (for example, nightly).

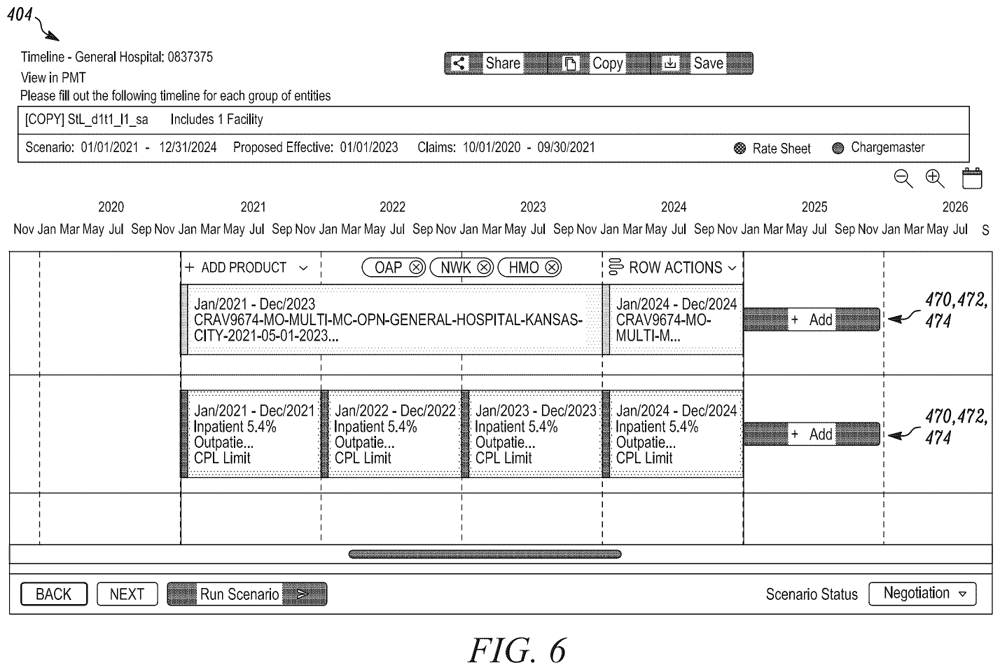

FIG. 6 is an example of a web front-end 404 that a user may use to select claims data 122 to be used in a simulation. For instance, a user, via the web front-end 404, may select medical claim data including one or more medical services or procedures previously performed, the time period of when the services or procedures were performed, and/or the medical service provider who performed the services or procedures. In some example configurations, the web front-end 404 may include a service provider selection portion 470, a service provider facility selection portion 472, and a time period selection portion 474.

### Flowchart

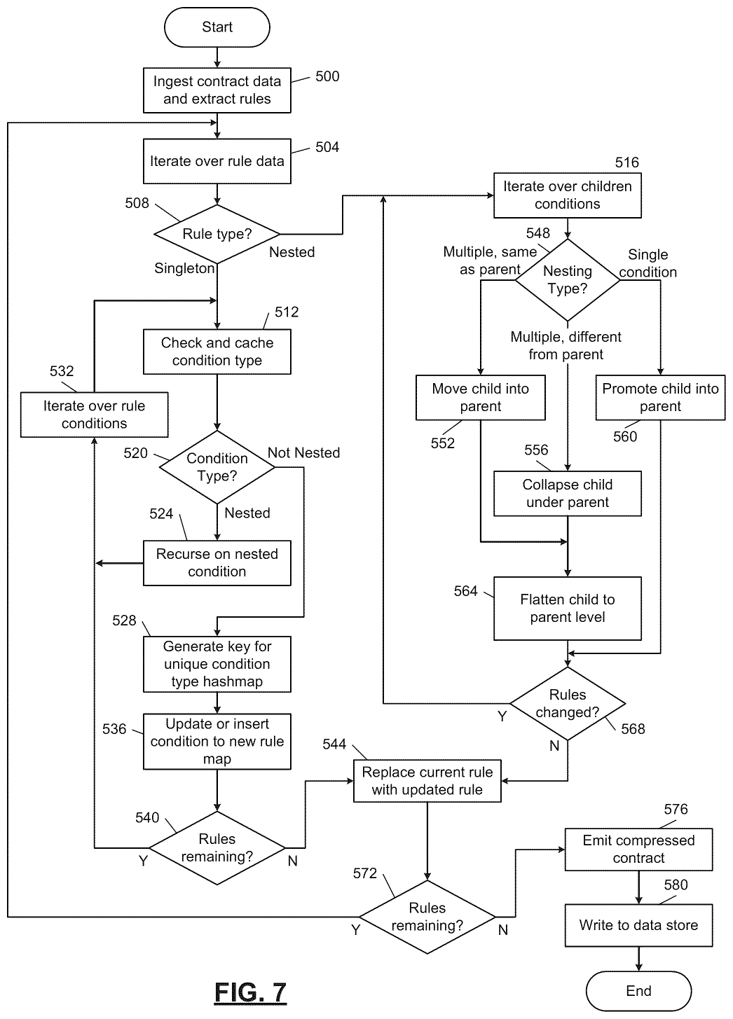

FIG. 7 is a flowchart of an example process for compressing (e.g., reducing, combining, simplifying, and/or eliminating, etc.) rules of a contract. The example process may be implemented to produce a compressed contract from an existing contract, which may or may not be compressed. Control begins at 500. At 500, the compression module 408 ingests contract data from an uncompressed contract 432 and extracts the rules (e.g., uncompressed rules 444) from the contract. In some examples, ingesting contract data may include retrieving the data from storage device 110, parsing its contents to extract relevant information, and then storing the information in the storage device 110 or other data structure that the compression module 408 can use to manage the information. Extracting the rules may include identifying and isolating the relevant rules embedded within the metadata of the contract. Extracting rules from contract metadata may involve parsing through the metadata to identify and isolate the rules, for example, using a set of predefined keywords or data structures that are known to correspond to rules or constraints. Once the rules have been extracted they may be further processed and/or used for various purposes such as validation, analysis, or execution.

Control proceeds to 504. At 504, the compression module 408 iterates over the rule data. In some examples, iterating over the rule data may include looping through all the rules and preforming an operation on each rule. Control proceeds to 508. At 508, the compression module 408 determines whether a rule is singleton rule or a nested rule. In various implementations, a singleton rule type includes a single condition (and one or more actions). A nested rule type may include a rule that includes one or more conditions contained within another condition. In some examples, a nested rule type may include a rule that is defined inside another rule as a sub-rule. A nested rule may apply additional conditions and/or actions to a specific subset of data that meets certain criteria. A nested rule may include more complex logic in comparison with a singleton rule.

If at 508 the answer is a singleton rule, control proceeds to 512. Otherwise control proceeds to 516. At 512, the compression module 408 checks and caches a condition type of the rule. Checking and caching a condition type may include verifying if a particular condition has been previously computed or stored in memory and, if so, reusing the cached value instead of recomputing. If a rule has multiple conditions of the same type, caching the result of the condition evaluation for each type may speed up the execution of the rule engine as it can avoid computing the same condition multiple times.

Control proceeds to 520. At 520, the compression module 408 determines the condition type of the rule. If at 520 the answer is nested, control proceeds to 524. Otherwise control proceeds to 528. At 524 the compression module 408 recurses on the nested condition. Recursing on the nested condition may include checking and caching condition types to any sub-condition or sub-rules that are nested with the current condition. By recursively checking and caching the condition types at each level, it may become possible to efficiently evaluate the rule as whole and determine the correct outcome based on the input data.

Control proceeds to 532. At 532, the compression module 408 iterates over the rule conditions. Control proceeds back to 512. At 528, the compression module 408 generates a key for a unique condition type hash map. Generating a key for a unique condition type hash map may include creating a unique identifier that can be used to store and retrieve a specific condition type in a hash map data structure. In various implementations, generating a key may include extracting specific information from the condition such as the name, value, and/or operator, and combining them into a string or hash value that is unique to that condition. The key may be used as the index for storing the condition in the hash map, allowing for efficient lookup and retrieval of conditions during rule processing.

Control proceeds to 536. At 536, the compression module 408 updates or inserts the condition to a new rule map. Updating or inserting the condition to a new rule map may include adding the condition to a new map or updating an existing one if it already exists in the map. In various implementations, the conditions of the input rule are being iterated over and, for each condition, a new rule map may be constructed that contains the condition as a key value pair. If a condition of the same type already exists in the rule map, the condition may be updated with the new information. If not, a new condition may be inserted into the rule map. This process allows for easy access to a condition of a particular type when evaluating a rule.

Control proceed to 540. At 540, the compression module 408 determines whether any rules remain in the contract to be evaluated. If at 540 the answer is no, control proceeds to 544. Otherwise, control proceeds back to 532.

At 516, the compression module 408 is configured to iterate over the children conditions of the nested rule. In various implementations, a parent condition may have one or more child conditions nested underneath it. The child conditions may include simple conditions or they may include other nested conditions. Iterating over the children conditions may include evaluating each condition.

Control proceeds to 548. At 548, the compression module 408 determines the nesting type of the child conditions. If the answer at 548 is multiple, same as parent, control proceeds to 552. If the answer at 548 is multiple, different than parent control proceeds to 556. If the answer at 548 is single condition control proceeds to 560.

At 552, the compression module 408 moves at least one child condition into the parent condition. If a nested child condition is of the same nesting type as the parent condition, the child condition may be nested in the same way as the parent. For instance, if the parent condition includes an AND logic operator, then the nested child condition may also include an AND logic operator, and/or if the parent condition includes an OR logic operator, then the nested child condition may also include an OR logic operator. Moving a child condition into a parent condition may include making the child condition part of the parent and no longer a separate condition. This may be done by updating the parent condition to include the child condition. By moving a child condition into the parent condition, the child condition may inherit properties from the parent condition and/or may be evaluated together with the parent condition. Control proceeds to 564.

At 556, the compression module 408 collapses at least one child condition under the parent condition. If a nested condition is of a different nesting type from the parent condition, the child condition may have a different level of nesting than the parent condition. For instance, if the parent condition includes a sequential condition which executes the child conditions in a specific order and a child condition includes a parallel condition which executes additional child conditions simultaneously, then the nesting type of the child condition may be different from the parent condition. Collapsing a child condition under a parent condition may include merging the child condition with the parent condition. This may include moving the child condition under the parent condition and removing the child condition. By collapsing the child condition under the parent condition, the compression module 408 only needs to evaluate the parent condition and does not need to check the child condition separately. This may reduce processing time and/or resources required to evaluate the rule. Control proceeds to 564.

At 560, the compression module 408 promotes at least one child condition into the parent condition. Promoting a child condition into a parent condition may include removing the child condition from its current nested position and placing the child condition at the same level as the parent condition. Control proceeds to 564.

At 564, the compression module 408 flattens at least one child condition to the level of the parent condition. Flatting a child condition to the level of a parent condition may include moving the child condition up one level in the rule hierarchy to the parent level. This process may be repeated for each child condition until all of the conditions have been moved to the parent condition. This simplifies the rule since unnecessary levels of nesting in the rule hierarchy are removed. Control proceeds to 568.

At 568, the compression module 408 determine whether the rule has been changed. If the answer at 568 is yes then control proceeds back to 516. Otherwise, control proceeds to 544. At 544, the compression module 408 replaces the current rule (e.g., uncompressed rule 440) with the updated rule (e.g., compressed rule 444). Control proceeds to 572. At 572, the compression module 408 determines whether any rules remain in the contract to be evaluated. If at 572 the answer is yes then control proceeds back to 504. Otherwise, control proceeds to 576.

At 576, the compression module 408 emits the newly created compressed contract 436. Control proceeds to 580. At 580, the compression module 408 writes the compressed contract 436 to the data store (e.g., the storage device 110).

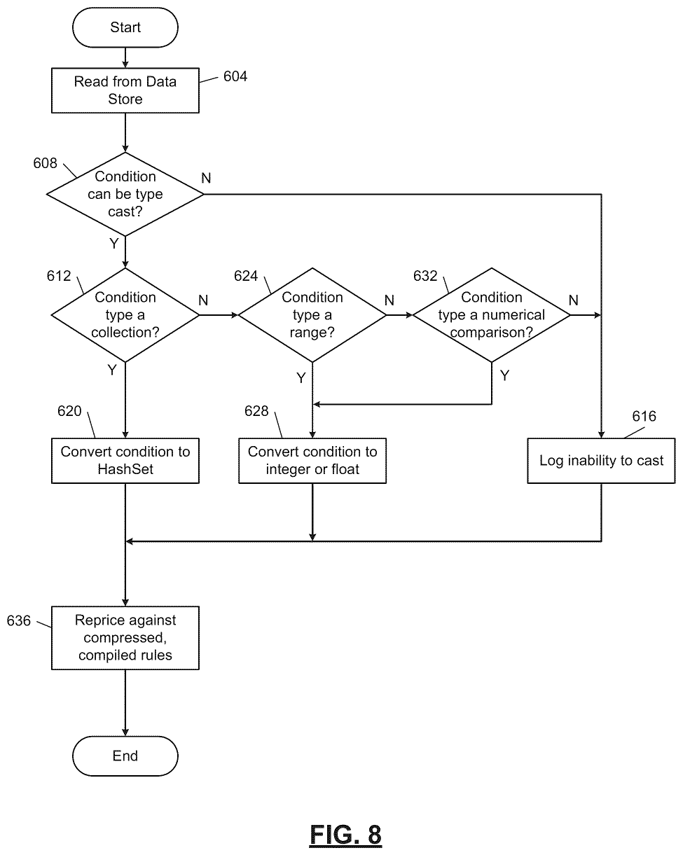

In FIG. 8, example execution of a simulation is shown. At 604, control reads the rules from a data store. At 608, control determines whether the condition can be type cast. If so, control transfers to 612; otherwise, control transfers to 616. At 612, control determines whether the condition type is a collection. If so, control transfers to 620; otherwise, control transfers to 624. At 624, control determines whether the condition type is a range. If so, control transfers to 628; otherwise, control transfers to 632. At 632, control determines whether the condition type is a numerical comparison. If so, control transfers to 628; otherwise, control transfers to 616.

At 616, the condition has not been type cast, and control logs this inability. Control then continues at 636. At 620, control converts the condition to a collection of unique items, such as a hashmap—for example, in the Java programming language, the HashSet class may be used. Control then continues at 636. At 628, control converts the condition to an integer or a floating point data type. Control then continues at 636.

At 636, control reprices a set of claim records using a rule set of the compressed, compiled rules. For example, control may evaluate each record of the set of claim records against the set of rules. For a selected record, control determines a selected rule of the rule set that applies to the selected record based on the set of conditions for the selected rule. In various implementations, if no rules of the rule set apply to the selected record, the selected record may be flagged as unprocessable.

For the selected rule, control performs the set of actions defined for the selected rule. In various implementations, control then determines whether any additional rules of the rule set apply to the selected record. If an additional rule of the rule set applies to the selected record, based on the set of conditions defined for the additional rule, control selects the additional rule and performs the set of actions defined for the selected rule.

In various implementations, a total metric may be calculated across the set of claim records. For example, a feature of merit for each record of the set of claim records may be calculated—the feature of merit might include payment, cost, net cost, net profit, discount value, etc. The total metric may then be a sum of the feature of merit across all of the set of claim records. In various implementations, the total metric may be accumulated by adding the feature of merit to the total metric as each of the set of claim records is processed. Control then ends.

### Example JSON

As an example only, the following JSON structure includes a set of rules that are at least partially uncompressed.

```
“conditions”: {
  “all”: [
  {
    “any”: [
    {
    “value”: [
    “25”
    ],
    “operator”: “in_list”,
    },
    {
    “value”: [
    “26”
    ],
    “operator”: “in_list”,
    },
    {
    “value”: [
    “27”
    “operator”: “in_list”,
    }
    ]
  }
  ]
},
“actions”: [
{
  “name”: “discount”,
  “params”: {
  “percent”: 50
}
}
]
}
],
}
```

As an example only, the following JSON structure includes a set of rules that were compressed as described above.

```
{
“conditions”: {
  “any”: [
  {
  “value”: [
  “25”,
  “26”,
  “27”
  “operator”: “in_list”,
  }
  ]
},
“actions”: [
{
  “name”: “discount”,
  “params”: {
  “percent”: 50
}
}
]
}
],
}
```

### CONCLUSION

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. In the written description and claims, one or more steps within a method may be executed in a different order (or concurrently) without altering the principles of the present disclosure. Similarly, one or more instructions stored in a non-transitory computer-readable medium may be executed in a different order (or concurrently) without altering the principles of the present disclosure. Unless indicated otherwise, numbering or other labeling of instructions or method steps is done for convenient reference, not to indicate a fixed order.

Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements as well as an indirect relationship where one or more intervening elements are present (either spatially or functionally) between the first and second elements.

The phrase “at least one of A, B, and C” should be construed to mean a logical (A OR B OR C), using a non-exclusive logical OR, and should not be construed to mean “at least one of A, at least one of B, and at least one of C.” The term “set” does not necessarily exclude the empty set—in other words, in some circumstances a “set” may have zero elements. The term “non-empty set” may be used to indicate exclusion of the empty set—in other words, a non-empty set will always have one or more elements. The term “subset” does not necessarily require a proper subset. In other words, a “subset” of a first set may be coextensive with (equal to) the first set. Further, the term “subset” does not necessarily exclude the empty set—in some circumstances a “subset” may have zero elements.

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” can be replaced with the term “controller” or the term “circuit.” In this application, the term “controller” can be replaced with the term “module.”

The term “module” may refer to, be part of, or include processor hardware (shared, dedicated, or group) that executes code and memory hardware (shared, dedicated, or group) that stores code executed by the processor hardware.

The module may include one or more interface circuit(s). In some examples, the interface circuit(s) may implement wired or wireless interfaces that connect to a local area network (LAN) or a wireless personal area network (WPAN). Examples of a LAN are Institute of Electrical and Electronics Engineers (IEEE) Standard 802.11-2020 (also known as the WIFI wireless networking standard) and IEEE Standard 802.3-2018 (also known as the ETHERNET wired networking standard). Examples of a WPAN are IEEE Standard 802.15.4 (including the ZIGBEE standard from the ZigBee Alliance) and, from the Bluetooth Special Interest Group (SIG), the BLUETOOTH wireless networking standard (including Core Specification versions 3.0, 4.0, 4.1, 4.2, 5.0, and 5.1 from the Bluetooth SIG).

The module may communicate with other modules using the interface circuit(s). Although the module may be depicted in the present disclosure as logically communicating directly with other modules, in various implementations the module may actually communicate via a communications system. The communications system includes physical and/or virtual networking equipment such as hubs, switches, routers, and gateways. In some implementations, the communications system connects to or traverses a wide area network (WAN) such as the Internet. For example, the communications system may include multiple LANs connected to each other over the Internet or point-to-point leased lines using technologies including Multiprotocol Label Switching (MPLS) and virtual private networks (VPNs).

In various implementations, the functionality of the module may be distributed among multiple modules that are connected via the communications system. For example, multiple modules may implement the same functionality distributed by a load balancing system. In a further example, the functionality of the module may be split between a server (also known as remote, or cloud) module and a client (or, user) module. For example, the client module may include a native or web application executing on a client device and in network communication with the server module.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

The memory hardware may also store data together with or separate from the code. Shared memory hardware encompasses a single memory device that stores some or all code from multiple modules. One example of shared memory hardware may be level 1 cache on or near a microprocessor die, which may store code from multiple modules. Another example of shared memory hardware may be persistent storage, such as a solid state drive (SSD) or magnetic hard disk drive (HDD), which may store code from multiple modules. Group memory hardware encompasses a memory device that, in combination with other memory devices, stores some or all code from one or more modules. One example of group memory hardware is a storage area network (SAN), which may store code of a particular module across multiple physical devices. Another example of group memory hardware is random access memory of each of a set of servers that, in combination, store code of a particular module.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. Such apparatuses and methods may be described as computerized apparatuses and computerized methods. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A computerized method comprising:
initiating, via a user, an operation on logical descriptive data stored in a storage device, wherein the logical descriptive data includes a set of uncompressed rules each including a set of conditions expressed as a Boolean algebraic expression;
determining whether each of the uncompressed rules includes a singleton rule or a nested rule; and
in response to at least one of the uncompressed rules including a nested rule:
compressing the nested rule to form a compressed rule;
replacing the nested rule with the compressed rule; and
updating the logical descriptive data to include the compressed rule.

2. The method of claim 1 wherein initiating the operation on the logical descriptive data includes at least one of modifying some of the logical descriptive data, updating some of the logical descriptive data, and adding new data.

3. The method of claim 1 wherein each of the uncompressed rules includes a set of actions to take if the set of conditions is met.

4. The method of claim 3 wherein determining whether each of the uncompressed rules includes a singleton rule or a nested rule includes determining whether the set of conditions of each of the uncompressed rules includes a singleton type or a nested type.

5. The method of claim 4 further comprising, in response to at least one of the uncompressed rules including a set of conditions having the singleton type, generating a unique identifier that can be used to store and retrieve the set of conditions having the singleton type in a hash map data structure.

6. The method of claim 4 further comprising, in response to at least one of the uncompressed rules including a set of conditions having the nested type, determining the nesting types of a parent condition of the set of conditions and a set of child conditions of the set of conditions.

7. The method of claim 6 further comprising, in response to the set of child conditions including multiple child conditions having a nesting type matching the parent condition, moving at least one of the child conditions into the parent condition.

8. The method of claim 6 further comprising, in response to the set of child conditions including multiple child conditions having a different nesting type as the parent condition, collapsing at least one of the child conditions into the parent condition.

9. The method of claim 6 further comprising, in response to the set of child conditions including a single child condition, promoting the single child condition into the parent condition.

10. The method of claim 1 further comprising:
executing a simulation using the logical descriptive data including the compressed rule; and
determining a valuation value of the logical descriptive data.

11. The method of claim 1 wherein the logical descriptive data includes medical pricing data.

12. The method of claim 1 further comprising executing the compressed rule on a data record, including:
determining whether the compressed rule applies to the data record based on the set of conditions of the compressed rule; and
in response to a determination that the compressed rule applies, performing each action of a set of actions defined by the compressed rule.

13. The method of claim 12 wherein the executing the compressed rule is performed without decompressing the compressed rule.

14. The method of claim 1 further comprising discarding ones of the set of uncompressed rules that are encompassed by the compressed rule.

15. A system comprising:
processor hardware; and
memory hardware configured to store instructions that, when executed by the processor hardware, cause the processor hardware to perform operations, wherein the operations include:
initiating an operation on logical descriptive data stored in a storage device, wherein the logical descriptive data includes a set of uncompressed rules each including a set of conditions expressed as a Boolean algebraic expression;
determining whether each of the uncompressed rules includes a singleton rule or a nested rule; and
in response to at least one of the uncompressed rules including a nested rule:
compressing the nested rule to form a compressed rule;
replacing the nested rule with the compressed rule; and
updating the logical descriptive data to include the compressed rule.

16. The system of claim 15 wherein initiating the operation on the logical descriptive data includes at least one of modifying some of the logical descriptive data, updating some of the logical descriptive data, and adding new data.

17. The system of claim 15 wherein each of the uncompressed rules includes a set of actions to take if the set of conditions is met.

18. The system of claim 17 wherein determining whether each of the uncompressed rules includes a singleton rule or a nested rule includes determining whether the set of conditions of each of the uncompressed rules includes a singleton type or a nested type.

19. The system of claim 18 further comprising, in response to at least one of the uncompressed rules including a set of conditions having the singleton type, generating a unique identifier that can be used to store and retrieve the set of conditions having the singleton type in a hash map data structure.

20. A non-transitory computer-readable medium storing processor-executable instructions, the instructions comprising:
initiating an operation on logical descriptive data stored in a storage device, wherein the logical descriptive data includes a set of uncompressed rules each including a set of conditions expressed as a Boolean algebraic expression;
determining whether each of the uncompressed rules includes a singleton rule or a nested rule; and
in response to at least one of the uncompressed rules including a nested rule:
compressing the nested rule to form a compressed rule;
replacing the nested rule with the compressed rule; and
updating the logical descriptive data to include the compressed rule.
